(19) United States
(12) Patent Application Publication
(10) Pub. No.: US 2008/0198349 A1
(43) Pub. Date: Aug. 21, 2008

(54) Film Printing Head Having Hybrid Lenses

(76) Inventors: Youngshik Yoon, Valencia, CA (US); Sek Loong Chai, Santa Clarita, CA (US); David Michael Gilmartin, Chino Hills, CA (US)

Correspondence Address: Joseph J. Laks;Thomson Licensing LLC, 2 Independence Way, Patent Operations, PO Box 5312, PRINCETON, NJ, 08543, US

(21) Appl. No.: 11/885,194

(22) PCT Filed: Jun. 7, 2005
(86) PCT No.: PCT/US05/19906

§ 371 Date: Aug. 28, 2007

Related U.S. Application Data
(60) Provisional application No. 60/659,169, filed on Mar. 7, 2005.
(60) Provisional application No. 60/659,168, filed on Mar. 7, 2005.

(51) Int. Cl. G03B 27/52

(52) U.S. Cl. 355/32

(57) ABSTRACT

There are provided film printing systems and methods for printing images on one of two different width film stocks. A method for printing images on one of two different width film stocks includes the step of combining each of three different color light streams into a combined color stream. The method further includes the step of directing the combined color stream into a hybrid lens that focuses the combined color stream onto one of the two different width film stocks such that a uniformity of the combined color stream remains the same regardless of film width.

### CROSS-REFERENCE TO RELATED APPLICATIONS

This application claims the benefit under 35 U.S.C. 119(e) of U.S. Provisional Applications Ser. Nos. 60/659,169 and 60/659,168, both filed Mar. 7, 2005, both of which are incorporated by reference herein in their entireties.

### FIELD OF THE INVENTION

The present invention relates generally to film printing and, more particularly, to a high performance film printing head.

### BACKGROUND OF THE INVENTION

Turning to FIG. 1, a conventional film printing system is indicated generally by the reference numeral 100. The film printing system 100 includes a light box 110 and a printing head 120. The light box 110 includes a light valve for red light (hereinafter “red light valve”) 112, a light valve for blue light (hereinafter “blue light valve”) 114, a light valve for green light (hereinafter “green light valve”) 116, and one or more lenses (each indicated generally by the reference numeral 118). The printing head 120 also includes one or more lenses (each indicated generally by the reference numeral 122).

As can be seen in FIG. 1, the size of two folding mirrors in the printed head 120, indicated specifically by the reference numerals 132 and 134, respectively, limit light delivery. That is, irrespective of how large the light beam shape is expanded in the light box 110, uniformity across the film width is not improved due to light loss (or vignetting).

Accordingly, in the conventional film printing system 100, the major difficulty is in the resulting two different light behaviors with respect to the directions of film width and film height. That is, in the conventional film printing system 100, in the film width direction, the light is to be spread, but in the film height direction, the light is to be focused. Thus, an anamorphic lens component is employed to control each light behavior separately. However, depending upon the thickness of the anamorphic lens, some light loss is experienced due to the defocus effect in the film height direction following a longer optical path. Also, due to the limited mechanical dimension of the anamorphic lens used in the conventional film printing system 100, vignetting becomes a serious issue with respect to uniformity. It is to be appreciated that as used herein, the phrases “defocus” and “focus quality” relate to, and may be used interchangeably with, the “density level” of the light passing through a given lens(es). As is known, the density level is related to (e.g., has an impact on) the resulting contrast and color depth in the film stock after printing has occurred.

In attempting to solve the above-described problems relating to the use of an anamorphic lens in the printing system 100, a number of attempts have been made, but all with undesirable end result. For example, one conventional solution is to modify the opto-mechanical layout in order to illuminate a wider film width. This involves replacing an existing lens component to deliver more light onto the film stock. However, this approach may still suffer light loss and the cost of implementing this approach may pose an obstacle in some circumstances. Yet another conventional approach is to insert a new anamorphic lens component after the folding mirror to improve uniformity. However, the cost of implementation and light loss are issues to be addressed in this approach. Moreover, with respect to the two preceding approaches, the separate implementation of only one of these approaches undesirably results in a picture that is not well balanced with respect to uniformity and contrast.

Accordingly, it would be desirable and highly advantageous to have a high performance film printing head that overcomes the above-identified problems of the prior art.

### SUMMARY OF THE INVENTION

These and other drawbacks and disadvantages of the prior art are addressed by the present invention, which is directed to a high performance film printing head.

According to an aspect of the present invention, there is provided a method for printing images on one of two different width film stocks. The method includes the step of combining each of three different color light streams into a combined color stream. The method further includes the step of directing the combined color stream into a hybrid lens that focuses the combined color stream onto one of the two different width film stocks such that a uniformity of the combined color stream remains the same regardless of film width.

According to another aspect of the present invention, there is provided a film printing system for printing images on one of two different width film stocks. The film printing system includes a light box for combining each of three different color light streams into a combined color stream. The film printing system further includes a hybrid lens for focusing the combined color stream onto one of the two different width film stocks such that a uniformity of the combined color stream remains the same regardless of film width

According to yet another aspect of the present invention, there is provided a method for printing images on one of two different width film stocks in a film printing system having at least two folding mirrors. The method includes the step of combining each of three different color light streams into a combined color stream. The method further includes the step of directing the combined color stream into a first anamorphic lens, disposed in between the at least two folding mirrors, to enhance a density level thereof. The method also includes the step of directing the combined color stream into a second anamorphic lens, disposed after the at least two folding mirrors, to focus the combined color stream onto one of the two different width film stocks such that a uniformity of the combined color stream remains the same regardless of film width.

According to still another aspect of the present invention, there is provided a film printing system having at least two folding mirrors. The film printing system includes a light box for combining each of three different color light streams into a combined color stream. The film printing system further includes a first anamorphic lens, disposed in between the at least two folding mirrors, for focusing the combined color stream to enhance a density level thereof. The film printing system also includes a second anamorphic lens, disposed subsequent to the at least two folding mirrors, for focusing the combined color stream onto one of two different width film stocks such that a uniformity of the combined color stream remains the same regardless of film width.

These and other aspects, features and advantages of the present invention will become apparent from the following detailed description of exemplary embodiments, which is to be read in connection with the accompanying drawings.

### BRIEF DESCRIPTION OF THE DRAWINGS

The present invention may be better understood in accordance with the following exemplary figures, in which:

FIG. 1 shows a block diagram for a conventional film printing system in accordance with the prior art;

FIG. 2 shows a block diagram for a film printing system in accordance with a first preferred embodiment of the principles of the present invention;

FIG. 3 shows a flow diagram for a method for printing film in accordance with second preferred embodiment the principles of the present invention;

FIG. 4 shows a block diagram for another film printing system in accordance with a third preferred embodiment with the principles of the present invention; and

FIG. 5 shows a flow diagram for another method for printing film in accordance with a forth preferred embodiment the principles of the present invention.

### DETAILED DESCRIPTION

The present invention is directed to a high performance film printing head. Advantageously, the present invention addresses the need for wider film in order to provide higher resolution picture quality.

The present invention is advantageously capable of being implemented on an existing 35 mm film printing head with slight modification, thereby resulting in a low cost transition and ease in implementation.

It is to be noted that with respect to the spreading of light onto a wider film stock than, e.g., the conventionally used 35 mm film stock, the film density of the wider film stock is expected to be less than that of 35 mm film stock, which results in a decrease in contrast. This problem is addressed by the present invention as described herein.

Accordingly, the present invention advantageously overcomes the limit of conventional printing systems, which are so limited due to their original design capability. The present invention broadens the light beam onto widened film for good uniformity and to deliver more light to improve contrast, thereby allowing more light onto a unit area of the film at a low cost.

The present description illustrates the principles of the present invention. It will thus be appreciated that those skilled in the art will be able to devise various arrangements that, although not explicitly described or shown herein, embody the principles of the invention and are included within its spirit and scope.

All examples and conditional language recited herein are intended for pedagogical purposes to aid the reader in understanding the principles of the invention and the concepts contributed by the inventor to furthering the art, and are to be construed as being without limitation to such specifically recited examples and conditions.

Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of illustrative circuitry embodying the principles of the invention. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

In the claims hereof, any element expressed as a means for performing a specified function is intended to encompass any way of performing that function. The invention as defined by such claims resides in the fact that the functionalities provided by the various recited means are combined and brought together in the manner which the claims call for. It is thus regarded that any means that can provide those functionalities are equivalent to those shown herein.

Advantageously, one exemplary embodiment of the present invention implements a new film printing head configuration that employs a hybrid lens (which is anamorphic negative and holographic) after the folding mirrors to achieve better uniformity across the film.

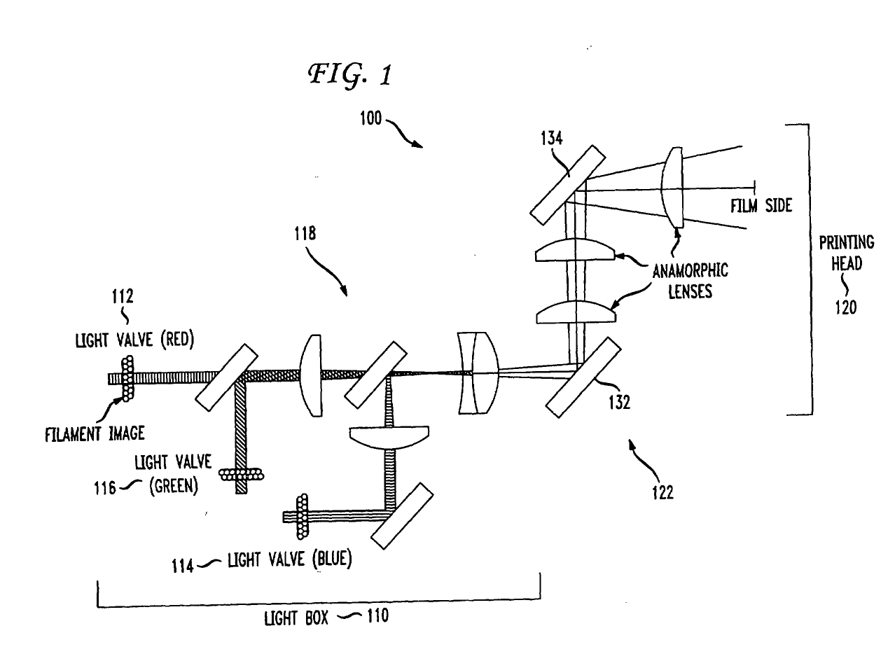

The use of a hybrid lens addresses the problems in the conventional film printing system (such as that shown and described with respect to FIG. 1) in that for the film width direction, the conventional system intends to spread the light, but for the film height direction, the light beam is to be focused. In fact, light focusing in the film height direction is a reason why glass lens solution is not employed because a certain thickness will cause defocus and light loss. Therefore, a hybrid lens is used to satisfy all the requirements in both directions (vertical and horizontal), and also to prevent any further light loss.

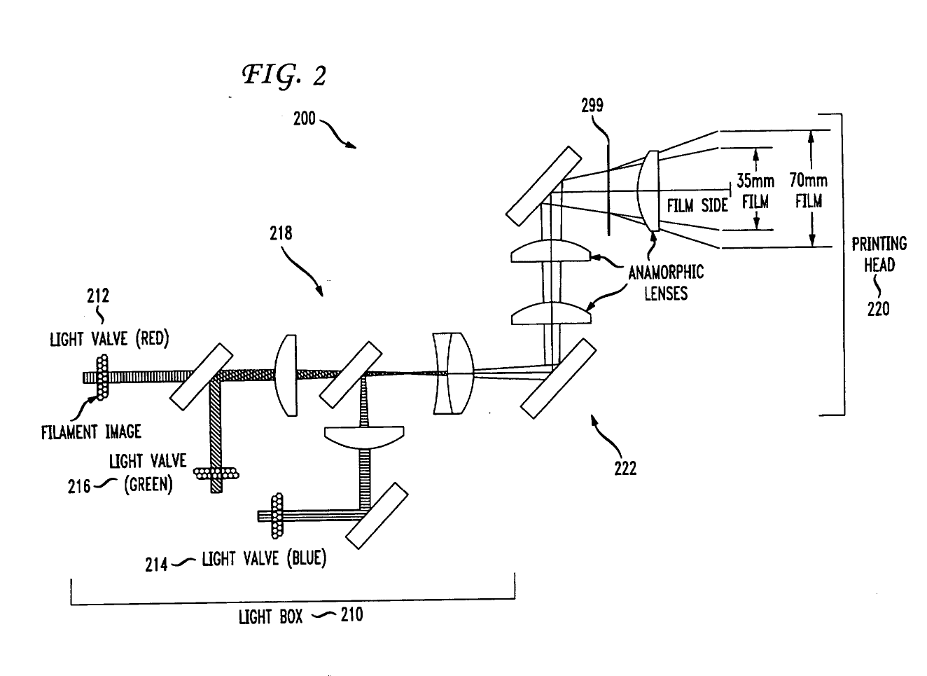

Turning to FIG. 2, a film printing system is indicated generally by the reference numeral 200. The film printing system 200 includes a light box 210 and a printing head 220. The light box 210 includes a light valve for red light (hereinafter “red light valve”) 212, a light valve for blue light (hereinafter “blue light valve”) 214, a light valve for green light (hereinafter “green light valve”) 216, and one or more lenses (each indicated generally by the reference numeral 218). The printing head 220 also includes one or more lenses (each indicated generally by the reference numeral 222).

In contrast to the conventional film printing system 100 shown and described with respect to FIG. 1, the film printing system 200 in accordance with the principles of the present invention includes a hybrid lens 299. The hybrid lens 299 is both anamorphic negative and holographic.

As a result, the uniformity of 70 mm film becomes the same as that of 35 mm film. Also, light delivery stays the same as 35 mm film. However, since 70 mm film is twice as wide as 35 mm film, the average light intensity over a unit area for the 70 mm film is approximately about half of that for 35 mm film.

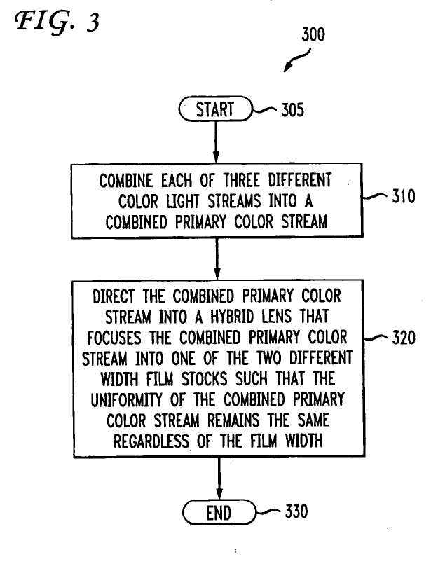

Turning to FIG. 3, a method for printing images on one of two different width film stocks is indicated generally by the reference numeral 300. The method of FIG. 3 may be used, e.g., with respect to the film printing system 200 shown and described with respect to FIG. 2. It is to be appreciated that the method steps shown and described with respect to FIG. 3 are directed to the present invention and, for reasons of clarity and brevity, may omit other steps performed during printing.

A start box 305 passes control to a function block 310. The function block 310 combines each of three different color light streams into a combined color stream, and passes control to a function block 320. The function block 320 directs the combined color stream into a hybrid lens that focuses the combined color stream onto one of the two different width film stocks such that the uniformity of the combined color stream remains the same regardless of the film width, and passes control to an end block 330.

Advantageously, another exemplary embodiment of the present invention, described immediately hereinafter, implements a new film printing head configuration that employs one or two anamorphic lens in a manner different than the prior art to achieve better uniformity across the film stock while preventing light loss.

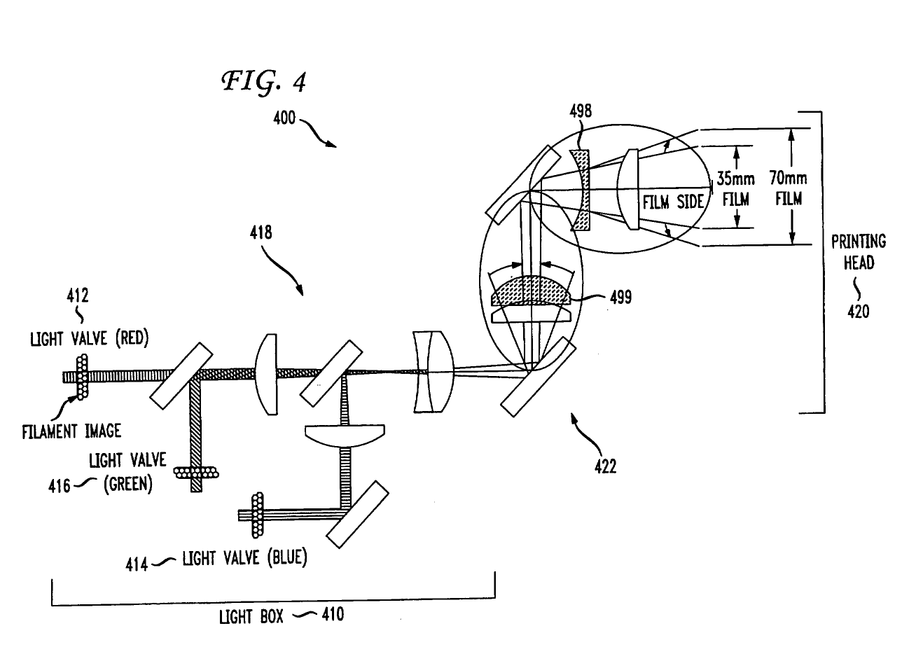

Turning to FIG. 4, a film printing system is indicated generally by the reference numeral 400. The film printing system 400 includes a light box 410 and a printing head 420. The light box 410 includes a light valve for red light (hereinafter “red light valve”) 412, a light valve for blue light (hereinafter “blue light valve”) 414, a light valve for green light (hereinafter “green light valve”) 416, and one or more lenses (each indicated generally by the reference numeral 418). The printing head 420 also includes one or more lenses (each indicated generally by the reference numeral 422).

In contrast to the conventional film printing system 100 shown and described with respect to FIG. 1, the film printing system 400 in accordance with the principles of the present invention includes two anamorphic lenses 498 and 499. It is to be appreciated that while both anamorphic lens 498 and anamorphic lens 499 are concurrently shown in FIG. 4, other embodiments of the present invention may only employ one of these two lenses, while overcoming the above-described problems of the prior art.

Anamorphic lens 498 is a negative anamorphic lens that is inserted after the folding mirrors to achieve better uniformity across the film. That is, anamorphic lens 498 provides for light expansion. However, giving the same amount of light onto film stock that is twice as wide as the conventionally used 35 mm film stock, density drops and, as a result, picture contrast becomes inferior to 35 mm. Anamorphic lens 499 is a positive anamorphic lens and is used to prevent light loss. Anamorphic lens 499 is of a stronger power than the existing lens (e.g., shown in FIG. 1), such that the light that reaches the film is increased. Therefore, contrast is improved. If both lens 498 and 499 are employed, then the picture quality remains the same as that of 35 mm film stock with respect to uniformity and contrast.

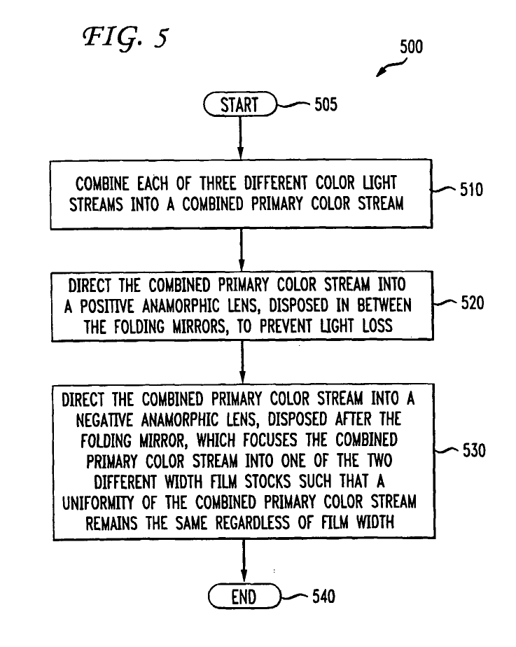

Turning to FIG. 5, a method for printing images on one of two different width film stocks is indicated generally by the reference numeral 500. The method of FIG. 5 may be used, e.g., with respect to the film printing system 500 shown and described with respect to FIG. 5. It is to be appreciated that the method steps shown and described with respect to FIG. 5 are directed to the present invention and, for reasons of clarity and brevity, may omit other steps performed during printing.

A start box 505 passes control to a function block 510. The function block 510 combines each of three different color light streams into a combined color stream, and passes control to a function block 520. The function block 520 directs the combined color stream into a positive anamorphic lens, disposed in between the folding mirror, to prevent light loss with respect to the combined color stream, and passes control to a function block 530. The function block 530 directs the combined color stream into a negative anamorphic lens, disposed after the folding mirror, which focuses the combined color stream onto one of the two different width film stocks such that a uniformity of the combined color stream remains the same regardless of film width, and passes control to an end block 540.

Accordingly, the present invention provides the following advantages over a conventional film printing system (e.g., such as that shown and described with respect to FIG. 1): minimum cost; maximum efficiency; and stray light control—high contrast.

These and other features and advantages of the present invention may be readily ascertained by one of ordinary skill in the pertinent art based on the teachings herein. Given the teachings herein, one of ordinary skill in the pertinent art will be able to contemplate these and similar implementations or configurations of the present invention.

Although the illustrative embodiments have been described herein with reference to the accompanying drawings, it is to be understood that the present invention is not limited to those precise embodiments, and that various changes and modifications may be effected therein by one of ordinary skill in the pertinent art without departing from the scope or spirit of the present invention. All such changes and modifications are intended to be included within the scope of the present invention as set forth in the appended claims.

1. A method for printing images on one of two different width film stocks, comprising the steps of:
combining each of three different color light streams into a combined color stream; and
directing the combined color stream into a hybrid lens that focuses the combined color stream onto one of the two different width film stocks such that a uniformity of the combined color stream remains the same regardless of film width.

2. The method of claim 1, wherein the hybrid lens is both anamorphic and holographic.

3. The method of claim 1, wherein the two different width film stocks include a 70 mm film stock and a 35 mm film stock.

4. A film printing system for printing images on one of two different width film stocks, comprising:
a light box for combining each of three different color light streams into a combined color stream; and
a hybrid lens for focusing the combined color stream onto one of the two different width film stocks such that a uniformity of the combined color stream remains the same regardless of film width.

5. The film printing system of claim 4, wherein the hybrid lens is both anamorphic and holographic.

6. The film printing system of claim 4, wherein the two different width film stocks include a 70 mm film stock and a 35 mm film stock.

7. A method for printing images on one of two different width film stocks in a film printing system having at least two folding mirrors, the method comprising the steps of:
combining each of three different color light streams into a combined color stream;
directing the combined color stream into a first anamorphic lens, disposed in between the at least two folding mirrors, to enhance a density level thereof; and
directing the combined color stream into a second anamorphic lens, disposed after the at least two folding mirrors, to focus the combined color stream onto one of the two different width film stocks such that a uniformity of the combined color stream remains the same regardless of film width.

8. The method of claim 7, wherein the two different width film stocks include a 70 mm film stock and a 35 mm film stock.

9. The method of claim 7, wherein the first anamorphic lens is a positive anamorphic lens, and the second anamorphic lens is a negative anamorphic lens.

10. The method of claim 7, wherein the film printing system has an existing anamorphic lens in between the at least two folding mirrors, and the first anamorphic lens is of a power higher than the existing anamorphic lens.

11. The method of claim 10, wherein the film printing system has another existing anamorphic lens in between the at least two folding mirrors, and the first anamorphic lens is of a higher power than the other existing anamorphic lens, and replaces the other existing anamorphic lens.

12. The method of claim 7, wherein the film printing system has an existing anamorphic lens subsequent to the at least two folding mirrors, and the second anamorphic lens is disposed subsequent to the at least two folding mirrors and preceding the existing anamorphic lens.

13. A film printing system having at least two folding mirrors, comprising:
a light box for combining each of three different color light streams into a combined color stream; and
a first anamorphic lens, disposed in between the at least two folding mirrors, for focusing the combined color stream to enhance a density level thereof; and
a second anamorphic lens, disposed subsequent to the at least two folding mirrors, for focusing the combined color stream onto one of two different width film stocks such that a uniformity of the combined color stream remains the same regardless of film width.

14. The film printing system of claim 13, wherein the two different width film stocks include a 70 mm film stock and a 35 mm film stock.

15. The film printing system of claim 13, wherein the first anamorphic lens is a positive anamorphic lens, and the second anamorphic lens is a negative anamorphic lens.

16. The film printing system, of claim 13, wherein the film printing system has an existing anamorphic lens in between the at least two folding mirrors, and the first anamorphic lens is of a power higher than the existing anamorphic lens.

17. The film printing system of claim 16, wherein the film printing system has another existing anamorphic lens in between the at least two folding mirrors, and the first anamorphic lens is of a higher power than the other existing anamorphic lens, and replaces the other existing anamorphic lens.

18. The film printing system of claim 13, wherein the film printing system has an existing anamorphic lens subsequent to the at least two folding mirrors, and the second anamorphic lens is disposed subsequent to the at least two folding mirrors and preceding the existing anamorphic lens.
